(19) United States
(12) Patent Application Publication
(10) Pub. No.: US 2007/0204712 A1
(43) Pub. Date: Sep. 6, 2007

(54) Series of power transmission devices and series of geared motors

(75) Inventor: Yasushi Mineshima, Kurashiki-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD.

(21) Appl. No.: 11/712,513

(22) Filed: Mar. 1, 2007

(30) Foreign Application Priority Data
Mar. 1, 2006 (JP) 2006-55145

(51) Int. Cl. F16H 1/20

(52) U.S. Cl. 74/413

(57) ABSTRACT

Series of power transmission devices and geared motors are provided at low costs. The series of power transmission devices output input motive power via at least three pairs of gear sets. In the series of power transmission devices, a gear ratio of an intermediate stage gear set is changed without changing a gear ratio of a first stage gear set and a gear ratio of a final stage gear set in order to differ a speed increasing and reducing ratio on the whole device.

### BACKGROUND OF THE INVENTION

1. Field of the Invention

The present invention relates to a power transmission device such as a speed reducer and a speed accelerator, and a geared motor.

2. Description of the Related Art

A geared motor as described in Japanese Patent Laid-Open Publication No. 2003-269552 is conventionally known. FIG. 7 shows this geared motor. In a geared motor 10, a motor 2 is integrated with a speed reducer 20 to reduce the speed of the rotation of the motor 2 (serving as a power source) by a plurality of gear sets for outputting.

A first stage gear set 31 is composed of a first pinion 31P directly formed at an end of a motor shaft 3 of the motor 2 and a first gear 31G engaged with the first pinion 31P. An intermediate stage gear set 32 is composed of a second pinion 32P coaxially rotating with the first gear 31G and a second gear 32G engaged with the second pinion 32P. A final stage gear set 33 is composed of a third pinion 33P coaxially rotating with the second gear 32G and a third gear 33G engaged with the third pinion 33P. In other words, after each of the gear sets 31, 32, and 33 reduces the speed of the rotation of the motor shaft 3 in three stages, the rotation is transmitted to an output shaft 50.

In a market, various geared motors with various rotational speed and torque of an output shaft and the like are demanded in accordance with the performance of a machine to which the output shaft is connected. If each part composing the geared motor is designed from the beginning in accordance with such a demand, cost will become very high. Thus, variations have been prepared by changing a gear ratio of a plurality of gears composing a power transmission device and the like.

Taking a case of the foregoing geared motor 10, appropriately changing the size (or the number of teeth) of the first to third pinions 31P, 32P, and 33P and the first to third gears 31G, 32G, and 33G can prepare the variations.

When each of the pinions and the gears has variations, however, the number of parts on the whole variations becomes very high. Also there is a problem about increase in costs on the whole device which is caused by additional costs (for example, inventory-carrying cost) necessary in accordance with the increase in the variations.

### SUMMARY OF THE INVENTION

In view of the foregoing problems, various exemplary embodiments of this invention provide a power transmission device and a geared motor having various variations with additional costs being minimized.

In the present invention, a series of power transmission devices each of which outputs input motive power via at least three pairs of gear sets is composed, so as to have different speed increasing and reducing ratios on the whole device, by sharing a gear ratio of a first stage gear set, a gear ratio of a final stage gear set, and respective positions of rotational centers of the gears composing the foregoing three pairs of gear sets, and by changing a gear ratio of an intermediate stage gear set.

When a first pinion 31P is directly formed at an end of a motor shaft 3 like the geared motor 10 of the conventional example, preparing various first pinions 31P means preparing various motor shafts 3 themselves and this requires costs from the viewpoint of a production lot in addition to that the motor shaft 3 is an originally expensive part. In addition to this, it is necessary to prepare many parts in advance and stock them in constant quantity. Preparing the various first pinions 31P is not preferable from the viewpoint of inventory-carrying cost too. In the case of a third gear 33G provided as a final stage, it is unavoidable that the third gear 33G has to have a large diameter (relatively as compared with the other gears). Preparing various gears with large diameters has brought a similar problem. Furthermore, according to the degree of change, it was necessary to also change the respective positions of rotational shafts supporting the respective gears (in other words, the respective positions of the rotational centers of the gears). In that case, it was necessary to further prepare variations in a casing for rotatably supporting the shaft and the like.

In the present invention, adopting foregoing structure makes it possible to provide a series of power transmission devices meeting market demand by preparing only gears composing an intermediate stage gear set as variations and appropriately combining a gear ratio of the intermediate stage gear set with another. Furthermore, the variations are made into the series by changing only the gear ratio of an intermediate gear set. Therefore, it is not necessary to prepare various casings and motor shafts (in which a pinion is formed) requiring high costs, so that it is possible to make the series at low costs.

As with above, the present invention provides a series of power transmission devices each of which outputs input motive power via at least three pairs of gear sets by sharing diameters of gears composing a first stage gear set, diameters of gears composing a final stage gear set, and respective positions of rotational centers of the gears composing the foregoing three pairs of gear sets, and by changing diameters of gears of an intermediate stage gear set in order to differ a speed increasing and reducing ratio on the whole device.

As described above, preparing only the gears composing an intermediate stage gear set as variations and appropriately combining diameters of gears composing an intermediate stage gear set with another make it possible to provide a series of power transmission devices meeting the market demand. Furthermore, the variations are made into the series by changing only the diameters of the gears composing the intermediate gear set. It is not necessary to prepare various casings and motor shafts (in which a pinion is formed) requiring high costs, so that it is possible to make the series at low costs.

Also the present invention provides a series of power transmission devices each of which outputs input motive power via at least an input gear and two pairs of gear sets by sharing a diameter of the input gear, diameters of gears composing a final stage gear set, and a position of a rotational center of the input gear, and respective positions of rotational centers of the gears composing the two pairs of gear sets, and by differing diameters of gears which exclude the input gear and compose a gear set except for the final stage gear set.

Accordingly, even if, for example, one of gears corresponding to a first stage gear set is directly formed in a motor shaft of a power source (for example, a motor), it is possible to provide a series of power transmission devices at low costs.

As with above, the present invention provides a series of power transmission devices each of which outputs input motive power via at least an input gear and two pairs of gear sets by sharing the number of teeth of the input gear, the numbers of teeth of gears composing a final stage gear set, a position of a rotational center of the input gear, and respective positions of rotational centers of the gears composing the two pairs of gear sets, and by differing the numbers of teeth of gears which exclude the input gear and compose a gear set except for the final stage gear set in order to differ a speed increasing and reducing ratio on the whole device.

Accordingly, even if, for example, one of gears corresponding to a first stage gear set is directly formed in a motor shaft of a power source (for example, a motor), it is possible to provide a series of power transmission devices at low costs.

Also the present invention provides a series of geared motors provided with at least three pairs of gear sets, in which one gear of a first stage gear set is directly formed in a motor shaft, by sharing a gear ratio of the first stage gear set, a gear ratio of a final stage gear set, and respective positions of rotational centers of the gears composing the three pairs of gear sets, and by differing a gear ratio of an intermediate stage gear set in order to differ a speed increasing and reducing ratio on the whole device.

Accordingly, even if an identical motor is used as a power source, it is possible to provide a series of geared motors with different rotation speed and torque of an output shaft at low costs.

As with above, the present invention provides a series of geared motors provided with at least three pairs of gear sets, in which one gear of a first stage gear set is directly formed in a motor shaft, by sharing diameters of gears composing the first stage gear set, diameters of gears composing a final stage gear set, and respective positions of rotational centers of the gears composing the three pairs of gear sets, and by differing diameters of gears composing an intermediate stage gear set in order to differ a speed increasing and reducing ratio.

Accordingly, even if an identical motor is used as a power source, it is possible to provide a series of geared motors with different rotation speed and torque of an output shaft at low costs.

In this specification and claims, the term “input gear” means a gear which is one of component parts of a power transmission device, and to which motive power from a power source is first transmitted.

Applying the present invention makes it possible to provide a series of power transmission devices and a series of geared motors at low costs. Also, it is possible to reduce the trouble of stock control of parts.

### BRIEF DESCRIPTION OF THE DRAWINGS

FIG. 1 is a front view of a geared motor which is provided with a first power transmission device composing one of a series according to an embodiment of the present invention;

FIG. 2 is a sectional view taken along the line II-II in FIG. 1;

FIG. 3 is a front view of a geared motor which is provided with a second power transmission device composing another one of the series according to an embodiment of the present invention;

FIG. 4 is a sectional view taken along the line IV-IV in FIG. 3;

FIG. 5 is a front view of a geared motor which is provided with a third power transmission device composing the other one of the series according to an embodiment of the present invention;

FIG. 6 is a sectional view taken along the line VI-VI in FIG. 5; and

FIG. 7 is a sectional view of a geared motor described in Japanese Patent Laid-Open Publication No. 2003-269552.

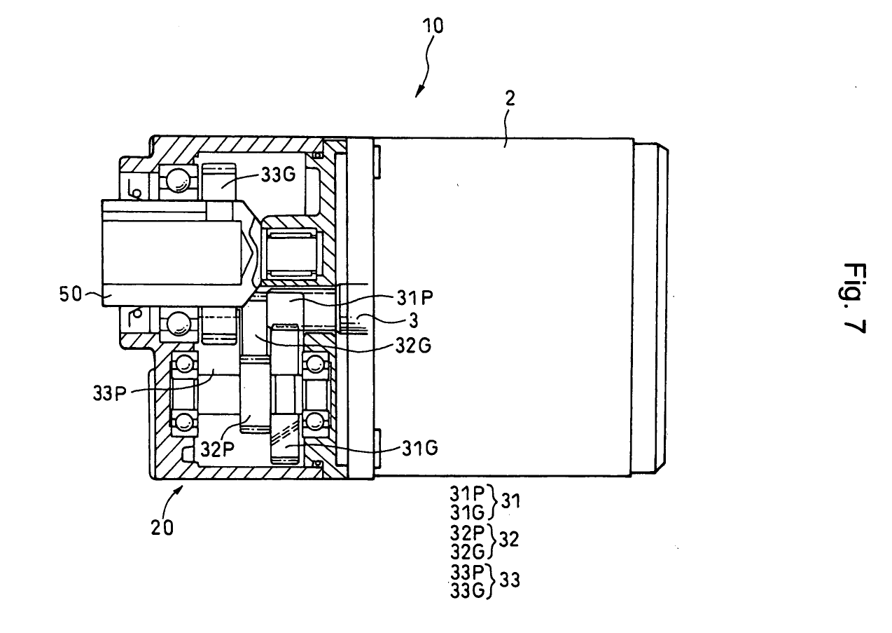

### DETAILED DESCRIPTION OF THE PREFERRED EMBODIMENTS

An exemplary embodiment according to the present invention will be hereinafter described in detail with reference to the accompanying drawings.

<Structure 1 Comprising One of a Series>

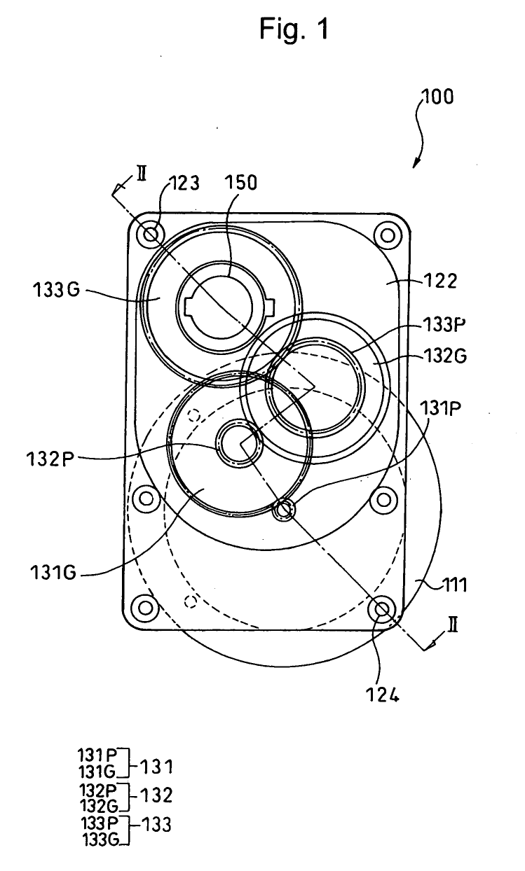

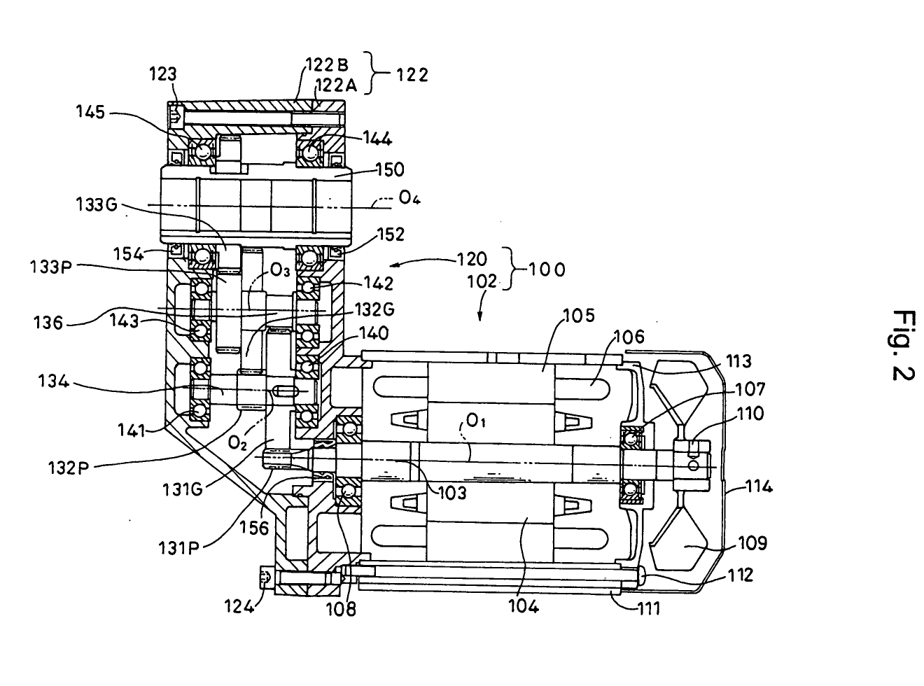

FIG. 1 is a front view of a geared motor 100 which is provided with a first speed reducer (power transmission device) composing one of a series according to the present invention. FIG. 2 is a sectional view taken along the line II-II in FIG. 1.

The geared motor 100 shown in FIGS. 1 and 2 comprises a motor 102 serving as a power source and a speed reducer 120 which reduces the speed of the rotation of the motor 102 and outputs the rotation.

The motor 102 is provided with a motor shaft 103 approximately at the center of a motor casing 111 in a cylindrical shape. An end cover 113 is disposed at one end of the cylindrical motor casing 111, and a first casing 122A is disposed at the other end thereof. The motor shaft 103 is supported by the end cover 113 via a first bearing 107, and is also supported by the first casing 122A via a second bearing 108. A rotor 104 is secured to approximately the center of the motor shaft 103 in an axial direction. In an inner peripheral surface of the motor casing 111, a stator 105 which is provided with an armature coil 106 is provided. The stator 105 has a slight gap with the rotor 104. The motor shaft 103 is disposed so as to penetrate the end cover 113 and the first casing 122A, and a cooling fan 109 is secured to a part of the motor shaft 103 (a part protruding from the end cover 113) with a bolt 110. Furthermore, a fan cover 114 is disposed on the motor casing 111 so as to cover this fan 109. The end cover 113 and the motor casing 111 are integrally connected by a connection bolt 112, and are secured to the first casing 122A described later on.

The speed reducer 120 comprises three gear sets 131, 132, and 133 and an output shaft 150 which are contained in a speed reducer casing 122. The speed reducer comprises the first casing 122A and a second casing 122B. The first casing 122A and the second casing 122B are connected and secured with bolts 123 and 124. One end of the motor shaft 103 of the foregoing motor 102 faces the inside of the speed reducer casing 122. A first pinion (helical pinion) 131P is directly formed at the end of the motor shaft 103. The first pinion 131P is rotatable together with the motor shaft 103 with respect to the center O1 of an axle. A first gear 131G (input gear) is disposed so as to be engaged with the first pinion 131P. The first pinion 131P and the first gear 131G compose the first stage gear set 131. In this exemplary embodiment, it is preferable that the first pinion 131P is integrally formed with the motor shaft 103 from the viewpoint of reducing the number of parts. However, it is also preferable that the first pinion 131P which is formed as a separate part is connected to the motor shaft 103 by clamping or the like.

The first gear 131G is secured to a first gear support shaft 134 which is supported by a third bearing 140 disposed in the first casing 122A and a fourth bearing 141 disposed in the second casing 122B. A second pinion 132P is formed on the first gear support shaft 134. In other words, the first gear 131G and the second pinion 132P are rotatable with respect to the same center O2 of an axle. Furthermore, the second pinion 132P is engaged with a second gear 132G. The second pinion 132P and the second gear 132G compose the intermediate stage gear set 132. The second gear 132G is secured to a second gear support shaft 136. The second gear support shaft 136 is supported by the first casing 122A via a fifth bearing 142 and is also supported by the second casing 122B via a sixth bearing 143. A third pinion 133P is secured on the second gear support shaft 136. In other words, the second gear 132G and the third pinion 133P are rotatable with respect to the same center O3 of an axle. Furthermore, the third pinion 133P is engaged with a third gear 133G which is secured to the output shaft 150. The third pinion 133P and the third gear 133G compose a final stage gear set 133. The output shaft 150 is supported by the first casing 122A via a seventh bearing 144, and is also supported by the second casing 122B via an eighth bearing 145. In other words, the third gear 133G is rotatable with respect to the center O4 of an axle of the output shaft 150. Reference numbers 152, 154, and 156 denote oil seals.

In this geared motor 100, the number of teeth of the first pinion 131P is 9, and the number of teeth of the first gear 131G is 67. The number of teeth of the second pinion 132P is 15, and the number of teeth of the second gear 132G is 56. The number of teeth of the third pinion 133P is 28, and the number of teeth of the third gear 133G is 50. As a result, the speed of the rotation of the motor shaft 103 is reduced by approximately 1/50 (details will be described later) and is output to the output shaft 150.

<Structure 2 Comprising Another One of the Series>

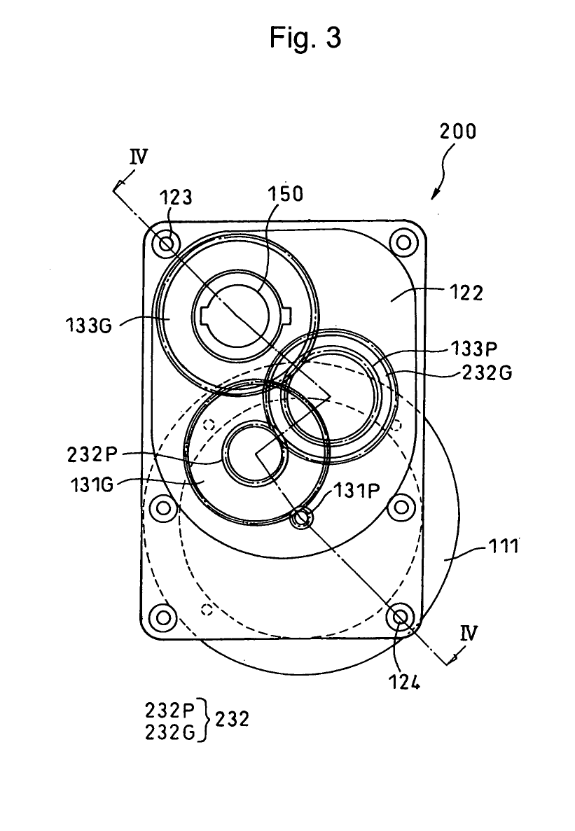

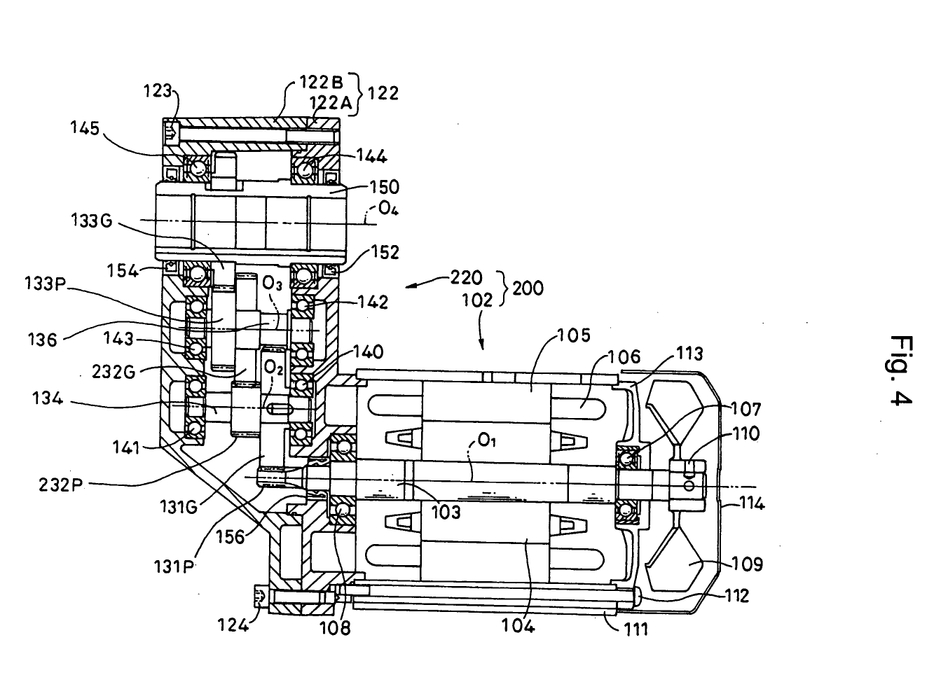

FIG. 3 is a front view of a geared motor 200 which is provided with a second speed reducer (power transmission device) composing another one of the series according to the present invention. FIG. 4 is a sectional view taken along the line IV-IV in FIG. 3.

The geared motor 200 shown in FIGS. 3 and 4 comprises a motor 102 serving as a power source and a speed reducer 220 which reduces the speed of the rotation of the motor 102 and outputs the rotation. The same reference numbers as those in the foregoing geared motor 100 refer to identical portions (parts), and reference numbers with the same last two digits refer to similar portions. Overlapping description will be omitted.

In this geared motor 200, the number of teeth of the first pinion 131P is 9, and the number of teeth of the first gear 131G is 67. The number of teeth of the second pinion 232P is 22, and the number of teeth of the second gear 232G is 49. The number of teeth of the third pinion 133P is 28, and the number of teeth of the third gear 133G is 50. As a result, the speed of the rotation of the motor shaft 103 is reduced by approximately 1/30 (details will be described later) and is output to the output shaft 150.

<Structure 3 Comprising the Other One of the Series>

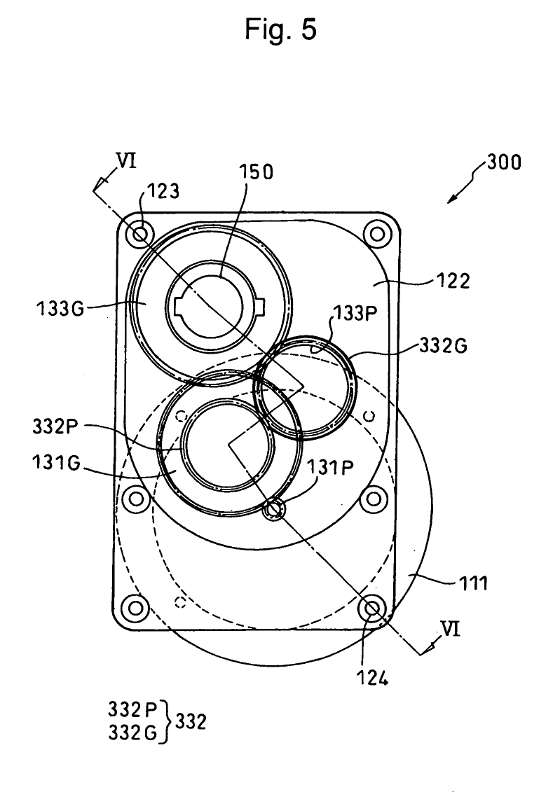

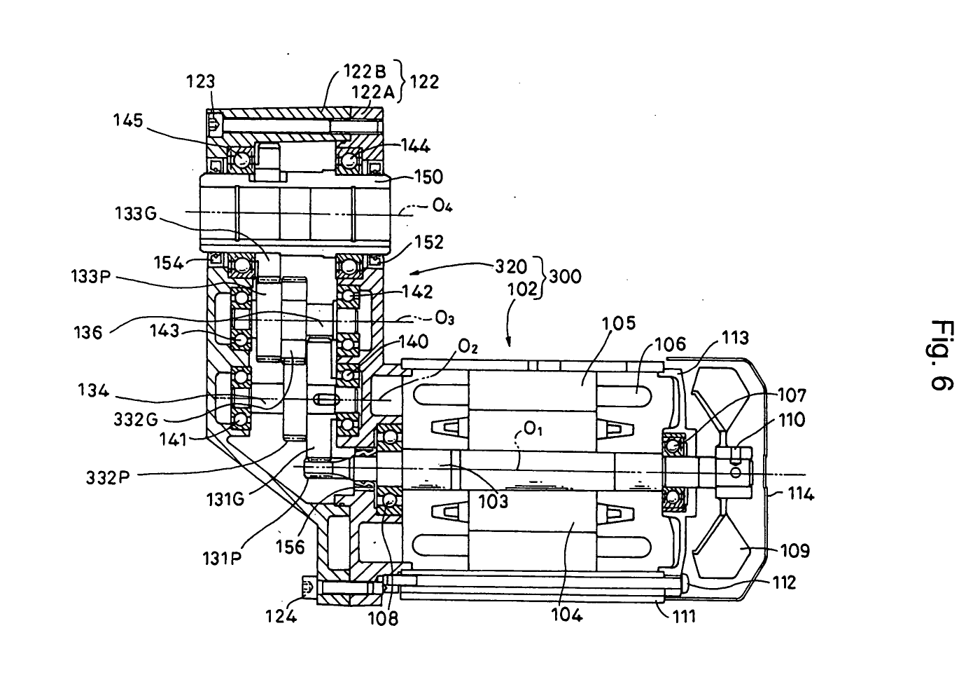

FIG. 5 is a front view of a geared motor 300 which is provided with a third speed reducer (power transmission device) composing the other one of the series according to the present invention. FIG. 6 is a sectional view taken along the line VI-VI in FIG. 5.

The geared motor 300 shown in FIGS. 5 and 6 comprises a motor 102 serving as a power source and a speed reducer 320 which reduces the speed of the rotation of the motor 102 and outputs the rotation. The same reference numbers as those in the foregoing geared motor 100 refer to identical portions (parts), and reference numbers with the same last two digits refer to similar portions. Overlapping description will be omitted.

In this geared motor 300, the number of teeth of the first pinion 131P is 9, and the number of teeth of the first gear 131G is 67. The number of teeth of the second pinion 332P is 34, and the number of teeth of the second gear 332G is 38. The number of teeth of the third pinion 133P is 28, and the number of teeth of the third gear 133G is 50. As a result, the speed of the rotation of the motor shaft 103 is reduced by approximately 1/15 (details will be described later) and is output to the output shaft 150.

As described above, among the geared motors 100, 200, and 300, only each of the pinions 132P, 232P, 332P and each of the gears 132G, 232G, and 332G composing the intermediate stage gear sets 132, 232, and 332 are different.

Next, the operation of the geared motor 100 will be described.

When the motor 102 is energized, magnetomotive force occurring in the armature coil 106 rotates the rotor 104. Since the rotor 104 is secured to the motor shaft 103, the motor shaft 103 starts rotating with respect to the center O1 of the axle. This rotation is transmitted to the first gear 131G through the first pinion 131P. The rotation of the first gear 131G rotates the first gear support shaft 134 with respect to the center O2 of the axle, so that the second pinion 132P secured to the first gear support shaft 134 also rotates with respect to the center O2 of the axle. The rotation of the second pinion 132P is further transmitted to the second gear 132G engaged therewith to rotate the second gear support shaft 136 with respect to the center O3 of the axle. Since the third pinion 133P is secured to the second gear support shaft 136, the third pinion 133P also starts rotating with respect to the center O3 of the axle. Furthermore, since the third pinion 133P is engaged with the third gear 133G, the third gear 133G rotates too. Moreover the third gear 133G is secured to the output shaft 150, and hence the output shaft 150 also rotates with respect to the center O4 of the axle in accordance with the rotation of the third gear 133G. In a series of flows, the rotation of the motor shaft 103 is transmitted to the output shaft 150 with reducing its speed in three stages. In other words, since the number of teeth of the first pinion 131P composing the first stage gear set 131 is 9 and the number of teeth of the first gear 131G is 67, the rotation of the motor shaft 103 is transmitted to the first gear support shaft 134 with reducing its speed by 9/67. Next, since the number of teeth of the second pinion 132P composing the intermediate stage gear set 132 is 15 and the number of teeth of the second gear 132G is 56, the rotation of the first gear support shaft 134 is transmitted to the second gear support shaft 136 with reducing its speed by 15/56. Then, since the number of teeth of the third pinion 133P composing the final stage gear set 133 is 28 and the number of teeth of the third gear 133G is 50, the rotation of the second gear support shaft 136 is transmitted to the output shaft 150 with reducing its speed by 28/50. As a result of speed reduction in the three stages, the rotation of the motor shaft 103 is transmitted to the output shaft 150 with finally reducing its speed by approximately 1/50.

Carrying out similar operation in the geared motors 200 and 300, the rotation of the motor shaft 103 is transmitted to the output shaft 150 with reducing its speed by approximately 1/30 in the geared motor 200, and with reducing its speed by approximately 1/15 in the geared motor 300 as results.

As described above, in each of the foregoing geared motors 100, 200, and 300, the same parts are used in the first pinion and the first gear composing the first stage gear set. As a result, the gear ratio of the first stage gear set and the diameters and the numbers of teeth of the gears composing the first stage gear set are same. The same parts are used in the third pinion and the third gear composing the final stage gear set. As a result, the gear ratio of the third stage gear set and the diameters and the numbers of teeth of the gears composing the final stage gear set are same too. The second pinion and the second gear composing the intermediate stage gear set, however, are composed of different parts in each of the geared motors 100, 200, and 300. Thus, the gear ratio, the diameters of the gears, the numbers of teeth, and the like are different in each power transmission device (geared motor). In other words, the gear ratio, the diameters, and the like of the gears composing the first stage gear set and the final stage gear set are unified and the gear ratio, the diameters, and the like of each gear composing the intermediate gear set are changed without changing the positions (the centers O1, O2, O3, and O4 of axles) of the rotational center of all gears even including each gears composing the intermediate stage gear set. This configuration makes it possible to prepare various speed reducing ratios (torque) as variations.

In each of the foregoing geared motors 100, 200, and 300, the positions (the centers O1, O2, O3, and O4 of axles) of the rotational center of each gear are not changed, so that it is possible to use the same speed reducer casing. The speed reducer casing unavoidably has to be large and have a complicated shape due to its structure for supporting and containing various parts, and hence the speed reducer casing costs high as a discrete part. Accordingly, sharing such a speed reducer casing among the series brings a great merit in costs.

Furthermore, each of the foregoing geared motors 100, 200, and 300 adopts the motor with the pinion, serving as a drive source, in which the pinion is directly formed in the motor shaft. The motor with the pinion can provide high cost down effect in comparison with a case where a gear is provided in a motor without a pinion because of the less number of parts. Unifying (sharing) the motor with the pinion in each of the geared motors 100, 200, and 300 can share the pinion with the motor among the series and hence can bring furthermore cost down effect. In other words, if a pinion directly formed in a motor shaft has variations to secure the variations of a speed reduction ratio on the whole geared motor, it is necessary to prepare a plurality of kinds of expensive motor shafts. Furthermore, it is necessary to prepare a plurality of kinds of motors as finished-products having a plurality of motor shafts, so that increase in the number of parts increases inventory-carrying cost. Therefore, as described in this exemplary embodiment, sharing the motor among the series brings a great merit in cost.

In the foregoing description, the speed of the rotation of the motor shaft is always reduced via the three gear sets, but the present invention is not limited thereto. The speed of the rotation of the motor shaft may be reduced in four or more stages, or may be not only reduced but also increased. Taking a case of four stages, for example, two pairs of “intermediate stage gear sets” which are defined in this specification and claims exist. Both (all) of the two pairs of the intermediate stage gear sets may have the variations described above, or only one (part) of them may have the variations.

This is not adopted in the exemplary embodiment described above, but if the speed reducer casing 122 has a symmetrical shape with respect to a line connecting the center O4 of the axle of the output shaft 150 and the center O1 of the axle of the motor shaft 103, it is possible to increase flexibility in attachment in the case of, for example, connecting to another machine.

The present invention is available for not only a power source of a machine such as a chain conveyer but also driving an industrial robot, an electric wheelchair, and the like.

The disclosure of Japanese Patent Application No. 2006-55145 filed Mar. 1, 2006 including specification, drawing and claim are incorporated herein by reference in its entirety.

What is claimed is:

1. A series of power transmission devices each of which outputs input motive power via at least three pairs of gear sets, wherein
a gear ratio of a first stage gear set, a gear ratio of a final stage gear set, and respective positions of rotational centers of the gears composing the three pairs of gear sets are same, and a gear ratio of an intermediate stage gear set is differed in order to differ a speed increasing and reducing ratio on the whole device.

2. A series of power transmission devices each of which outputs input motive power via at least three pairs of gear sets, wherein
diameters of gears composing a first stage gear set, diameters of gears composing a final stage gear set, and respective positions of rotational centers of the gears composing the three pairs of gear sets are same, and diameters of gears of an intermediate stage gear set are differed in order to differ a speed increasing and reducing ratio on the whole device.

3. A series of power transmission devices each of which outputs input motive power via at least an input gear and two pairs of gear sets, wherein
a diameter of the input gear, diameters of gears composing a final stage gear set, and a position of a rotational center of the input gear, and respective positions of rotational centers of the gears composing the two pairs of gear sets are same, and diameters of gears which exclude the input gear and compose a gear set except for the final stage gear set, are differed in order to differ a speed increasing and reducing ratio on the whole device.

4. A series of power transmission devices each of which outputs input motive power via at least an input gear and two pairs of gear sets, wherein
the number of teeth of the input gear, the numbers of teeth of gears composing a final stage gear set, a position of a rotational center of the input gear, and respective positions of rotational centers of the gears composing the two pairs of gear sets are same, and the numbers of teeth of gears which exclude the input gear and compose a gear set except for the final stage gear set, are differed in order to differ a speed increasing and reducing ratio on the whole device.

5. A series of geared motors provided with at least three pairs of gear sets, wherein:
one gear of a first stage gear set is directly formed on a motor shaft; and
a gear ratio of the first stage gear set, a gear ratio of a final stage gear set, and respective positions of rotational centers of the gears composing the three pairs of gear sets are same, and a gear ratio of an intermediate stage gear set is differed in order to differ a speed increasing and reducing ratio on the whole device.

6. A series of geared motors provided with at least three pairs of gear sets, wherein:
one gear of a first stage gear set is directly formed on a motor shaft; and
diameters of gears composing the first stage gear set, diameters of gears composing a final stage gear set, and respective positions of rotational centers of the gears composing the three pairs of gear sets are same, and diameters of gears composing an intermediate stage gear set are differed in order to differ a speed increasing and reducing ratio.
